(19) United States
(12) Patent Application Publication
(10) Pub. No.: US 2004/0059754 A1
(43) Pub. Date: Mar. 25, 2004

(54) Perceptual information processing system

(76) Inventors: Lauren Barghout, Oakland, CA (US); Lawrence W. Lee, San Francisco, CA (US)

Correspondence Address: LAWRENCE W. LEE, 1293 Dolores Street, San Francisco, CA, 94110, US

(21) Appl. No.: 10/618,543

(22) Filed: Jul. 11, 2003

Related U.S. Application Data
(60) Provisional application No. 60/395,661, filed on Jul. 13, 2002.

(51) Int. Cl. G06F 7/00

(52) U.S. Cl. 707/104.1

(57) ABSTRACT

A system and method for perceptual processing, organization, categorization, recognition, and manipulation of visual images and visual elements. The sysstem utilizes a dynamic perceptual organization schema to adaptively drive image-processing sub-algorithms. The schema incorporates knowledge about the visual world, human perception and image categories within its structure. A fuzzy logic query control system integrates the knowledge base and image processing drivers.

### CROSS REFERENCE TO RELATED APPLICATION

This application claims priority under 35 U.S.C. §119(e) to U.S. Provisional Patent Application No. 60/395,661, filed Jul. 13, 2002, by Lauren Barghout and Lawrence W. Lee, entitled “PERCEPTUAL INFORMATION PROCESSING SYSTEM,” which application is incorporated by reference herein.

### BACKGROUND OF THE INVENTION

1. Field of the Invention

The present invention relates to systems and methods for visual information processing based on cognitive science, dynamic perceptual organization, and psychophysical principles, and more particularly, to an extensible computational platform for processing, labeling, describing, organizing, categorizing, retrieving, recognizing, and manipulating visual images.

2. Description of the Related Art

This application references a number of different publications as indicated through out the specification by reference numbers enclosed in brackets, e.g., [x]. A list of these different publications ordered according to these reference numbers can be found below in Section 7 of the Detailed Description of the Preferred Embodiment. Each of these publications is incorporated by reference herein.)

The advent of digital photography and video recording technology has resulted in a vast increase in the amount of digital visual content being produced. As digital visual content grows in both quantity and scope, its management emerges as both a personal and business necessity. Traditional and emerging applications increasingly require systems and methods for coding, managing, retrieving, manipulating and inferring from visual information. Digital assets derive value from their content, yet coding and processing visual content for use in a variety of commercial and non-commercial purposes has proven to be a difficult problem.

Current technologies either rely on people manually annotating image content, or feature coding derived from systems analysis. Manual annotation of image content is both labor intensive and inaccurate, with the usefulness of the resulting annotations depending on the annotator's verbal interpretations. In the latter case, a system annotates images by comparing feature content to manually selected comparison images or feature templates. The result is often ambiguous and with limited usefulness.

Much research has been conducted on image processing and retrieval in the past twenty years. Most traditional systems code images using primitives derived from linear filters. These systems typically filter for a subset of spatial, orientation, temporal, spectral and disparity frequency. More advanced systems incorporate feature detectors and texton filters designed to signal the presence of texture sub-features. Some systems employ edge detection algorithms, inspired by the Canny edge detector [1].

These filters are generally applied linearly without consideration for the characteristics of the human perceptual organization, which is non-linear and preferential. For instance, while most traditional systems treat color as a continuous spectrum of wavelength, people perceive colors relative to a set of prototypical colors [2]. Similarly, while most traditional systems treat all pixels of an image equally and at the same depth, human vision tends to group certain pixels together and separate the “figures” from the “background.” Many other discrepancies exist.

After coding with the primitives described above, the traditional systems employ algorithms based on the statistical properties of these primitives within a particular image, or heuristics, or a combination of both, to perform annotation, management, and segmentation. These algorithms are both computationally intensive and numerically expensive, and generally not robust enough at providing useful results. For example, the returned segmentation regions do no correspond to human regions of figure and background.

To perform object recognition, most traditional systems rely on statistical methods, such as statistical analysis, template matching, histogram, or iconic matching, to recognize and classify images. These methods employ precise variables that are numerically expensive and are computationally demanding, while producing results that are limited to specialized applications.

As exemplified by the adage “A picture is worth a thousand words”, visual content defies verbal description because people use non-verbal processes to understand what they see. A technology that automatically describes images and codes these images relative to the non-verbal processes used by people would greatly extend the utility and, value of visual assets by allowing new applications to be created for management and employment of these visual assets efficiently, intelligently, and intuitively.

### SUMMARY OF INVENTION

The present invention concerns a human perception based information processing system for coding, managing, retrieving, manipulating and inferring perceptual information from digital images. The system emulates human visual cognition by adding categorical information to the ambient stimulus, providing a novel image labeling and coding system. The system utilizes a dynamic perceptual organization system to adaptively drive image-processing sub-algorithms. The system uses a uniquely designed data structure that maps labels to uniquely defined image structures called sub-images.

The present invention employs a set of uniquely defined visual primitives, incorporated within a novel schema in a hierarchical system that applies the schema structure at all processing levels, particularly, low-level feature processing, mid-level perceptual organization, and high-level category assignment. Furthermore, this schema structures can be applied to pre-classified images to yield object recognition, as well as incorporated into other expert systems.

The schema is hierarchical and encodes knowledge about the visual world and image categories within its structure such that general assumptions or perceptual hypotheses are placed at the top hierarchy level, primary visual primitives and categories are placed at the middle level, while attributes are placed at the sub-ordinate level. Psychological survey methods are employed to determine human category structure, in particular, primary category designation, super-ordinate, and sub-ordinate structure, and allow human visual knowledge to be incorporated within the scherma.

The schema allows the system to obviate computationally intensive algorithms and methods to yield classified images directly and accurately. It obviates computationally intensive statistical methods and numerically expensive precise variables. In the described embodiment, the system uses fuzzy logic to represent and manipulate the visual primitives incorporated in the schema, circumventing conventional requirements for precise measurements. It allows substitution of linguistic variables for numerical values and thus increases the generality of the system.

The present invention allows for the incorporation of data from established psychophysical processes measured by many investigators directly into the system. By using psychological survey methods to determine primary category designation and their super-ordinate and sub-ordinate structures, data from diverse fields such as archeology, anthropology, psychophysics, psychology, linguistics, art, computer science and any other human endeavor can be employed by this system.

The present invention incorporates the following novel features:

### 1. Perceptual Schema and Graded Membership

The present invention describes a schema definition that modifies both the cognitive science and computer science definition.

Cognitive scientists define a schema as “a mental framework for organizing knowledge, creating a meaningful structure of related concepts” [3]. Typically, schemas include other schemas, and organize general knowledge so that both typical and atypical information can be incorporated and can have varying, degrees of abstraction. For example, Komatsu [4] includes relationships among concepts, attributes within concepts, attributes in related concepts, concepts and particular context, specific concepts and general background knowledge, and causality. The cognitive schema are generally described in linguistic terms with fuzzy definition. In computer science, a schema is a structured framework used to describe the structure of database or document. A computer schema may be used to define the tables, fields, etc. of a database as well as the attribute, type, etc. of data elements in a document. The variables described in a computer schema are generally represented by crisp numeric values.

The present invention describes a perceptual schema, which is a computer schema that incorporates a hierarchical categorization structure inspired by human category theory, with super-ordinate categories, primary visual primitives, and specific visual attributes coded at different levels of the schema. In the described embodiment, the perceptual schema employs fuzzy variables, in particular, linguistic variables, to substitute graded membership values for crisp numeric values.

### 2. Uniform Schema Structure

The present invention employs the same schema structure at all levels of abstraction. In the described embodiment, each level of the system contains a schema with identical structural organization that consists of standardized data elements. This allows for a modular, flexible, and extensible architecture such that each processing unit may receive input from any other processing unit. Each processing unit organizes its input/output as a composite fuzzy query tree in a schema. All inputs and outputs employ the same schema structure. Furthermore, all processing units are organized to fit together within the-system according to a schema structure. Finally, the resulting description of the image employ the same schema structure.

### 3. Expert Knowledge

The present invention uses data derived from psychological survey methods for determining human visual category structure, in particular, primary category designation, super-ordinate, and sub-ordinate structure, to construct schemas that incorporate expert human knowledge. These psychological survey methods include reaction time measurements to determine primary verses super-ordinate designation; survey methods to measure typicality, which in turn can be used to determine primary, super-ordinate, and sub-ordinate relations; and motor interaction studies to determine primary category status. The hierarchical schema structure of the present invention provides super-ordinate, primary, and sub-ordinate levels that support these human cognitive schemas.

### 4. Adaptively Driven Image-processing Sub-algorithms

The present invention discloses a dynamic causal system with processing units that use variables and parameters that have been updated according to the conditions of the previous processing cycle. At each level of processing, a processing unit may introduce adjustment to variables in the schema. These variable adjustments allow the system to adapt results from earlier processing cycles. This adaptation process makes the system both temporally and contextually causal, allowing for a flexible, responsive dynamical system. The described embodiment illustrates the causal nature of the system where the system uses the default variables-and parameters defined in the schema during the initial processing cycle, adjusting them in the process, and uses the modified values in each subsequent processing cycles.

### 5. Standardized Image Tag

The present invention defines a new standardized data descriptor that maps labels to uniquely defined image structures, i.e., sub-images. The descriptor describes the metadata of an image file by tagging the sub-images with perceptual labels easily understood by human. The perceptual labels are defined according to perceptual psychology, which allows humans to naturally infer context, employing the Gestalt principle that the sum is greater than the parts. The descriptor can function with incomplete information and/or default information. As with alpha-numeric data, these descriptor tags can be manipulated and operated upon for specific purposes. The descriptor may be implemented in a number of formats including as ASCII text file, XML, SGML, and proprietary format. In the described embodiment, the descriptor is implemented in XML to allow easy data exchange and facilitate application transparency and portability.

### BRIEF DESCRIPTION OF DRAWINGS

FIG. 1 is a diagrammatic illustration of the perceptual information processing system according to one exemplary implementation;

FIG. 2 shows the processing flow of the system;

FIG. 3 illustrates adaptive processing strategy and the causal nature of the system;

FIG. 4 shows a more specific example of the adaptation process;

FIG. 5 illustrates how the system re-parameterizes information into category variables;

FIG. 6 shows the processing units and their corresponding levels;

FIG. 7 illustrates schema at multiple levels of abstraction;

FIG. 8 illustrates how the input and output linguistic variables form a schema;

FIG. 9 is a diagrammatic illustration of how a composite fuzzy query system is employed by the system;

FIG. 10 is a diagrammiatic illustration of the image descriptor;

FIG. 11 is an example embodiment of a general purpose software application using the present invention;

FIG. 12 shows an example of image retrieval;

FIG. 13 shows results of first level processing.

### DETAILED DESCRIPTION

In the following description, reference is made to the accompanying drawings which form a part hereof, and which show, by way of illustration, a preferred embodiment of the present invention. It is understood that other embodiments may be utilized and structural changes may be made without departing from the scope of the present invention.

The following detailed description of the preferred embodiment presents a specific embodiment of the present invention. However, the present invention can be embodied in a multitude of different ways as will be defined and covered by the claims.

### 1. Overview

This specification describes a system for visual information processing, that automatically codes images for easy processing, labeling, describing, organizing, retrieving, recognizing, and manipulating. The system integrates research from diverse and separate disciplines including cognitive science, non-linear dynamic systems, soft computing, perceptual organization, and psychophysical principles. The system allows automatic coding of visual images relative to non-verbal processes used by human and greatly extends the utility and value of visual assets by allowing new applications to be created for management and employment of these visual assets efficiently, intelligently, and intuitively.

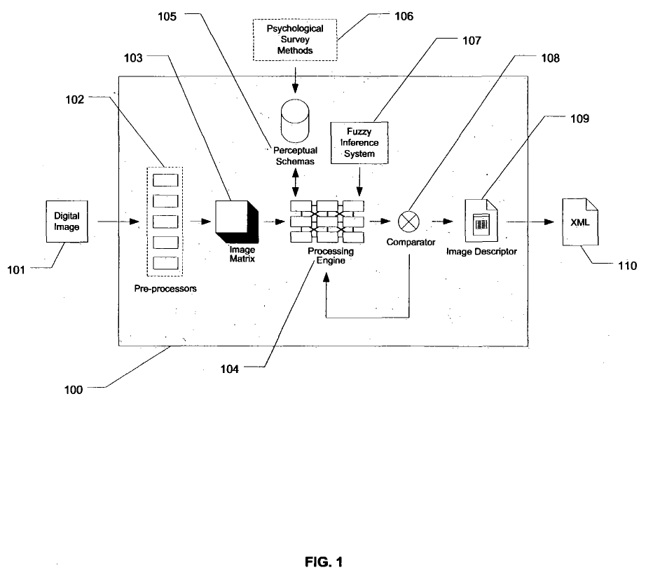

FIG. 1 shows a perceptual information processing system 100 according to one exemplary implementation. The system accepts as input a digital image 101 consisting of x rows by y columns of pixels. The digital image 101 is first processed by the pre-processors 102 which transform it into an m rows by n columns by three layers image matrix 103 where the location of m and n corresponds to the pixel location x and y of the digital image 101. The image matrix 103 encodes the hue, luminance, and saturation values of each pixel of the digital image 101, with the hue values encoded in the first layer, the luminance values encoded in the second layer, and the saturation values encoded in the third layer.

The image matrix 103 is then processed by the processing engine 104. The processing engine 104 is modular in design, with multiple processing units connected both in series and in parallel to drive various processes. Each processing unit contains one or more processors, a schema, and parameters that feeds back to the processors. Each processing unit implements algorithms to perform a specific function. Not all processing units will be employed in processing a task. The specific processing units employed can change depending on task requirements. The processing units implement algorithms designed to re-parameterize input to a categorical output space.

For example, a visual process within a color naming processing unit maps a 510 nm signal to the color name “green”. Color names such as “green” are encoded in a schema structure which incorporates knowledge about the visual world and perception. Each processing unit contains certain default inputs or receives input of the previous processing cycle in the same schema format. A re-parameterization engine organizes the new visual information. The processing unit then outputs an updated schema and parameter adjustments for the next processing cycle.

The processing engine 104 interact with the perceptual schemas 105 to obtain data to perform their specific functions and to update the values stored in the schemas. The perceptual schemas 105 are constructed with data derived from perceptual organization, psychophysics, and human category data obtained through psychological survey methods 106 such as typicality measurements, relative category ordinate designation, perceptual prototype, etc.

The schema and processing units employ fuzzy variables, which are linguistic variables that substitute graded membership for crisp numeric values. The processing engine 104 employ the fuzzy inference system 107 to process and update schema values. The use of fuzzy logic circumvent conventional requirements for precise measurements.

Viewed as a network, each processing unit corresponds to a node. On a computational level, each node represents a query with an initial visual state and a series of question/answer pairs. Fuzzy inference system is employed to apply heuristics to interpret the query. The overall pattern of node activity represents both visual knowledge and perceptual hypothesis. In this way, a question/answer path through the network automatically selects the visual processes best suited to process an image at a particular point according to its relation to the context at that point. The node outputs modify schema values and processor parameters such that the processing loop resets the parameters for the next processing cycle in a context dependent manner, enabling local processing decisions based on previous visual input, visual knowledge, and global context.

At the completion of each processing cycle, the comparator 108 compare the schema values to predefined completion criteria for the task and direct the system to either continue processing with updated parameters or to produce the image descriptor 109 for the digital image 101 accordingly. The image descriptor 109 encodes the visual properties and their corresponding pixel location, sub-image designation, and ordinate position within the perceptual schema. The image descriptor 109 may be described with an Extensible Markup Language (XML) document 110 to allow easy data exchange and facilitate application transparency and portability.

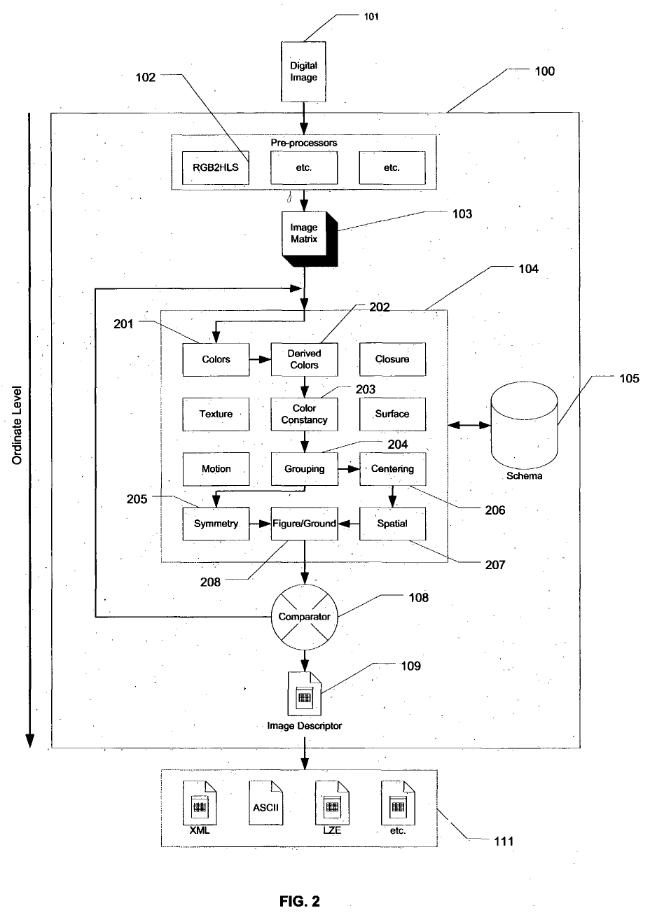

FIG. 2 shows an example of the processing flow. After being processed by the pre-processors 102, the image matrix 103 is passed to the processing engine 104. Each processing unit within the processing engine 104 consists of algorithms to perform a specific function. These algorithms may be implemented using fuzzy logic and objected-oriented computer language such as C or C++. Each processing unit is associated with a schema that defines the elements and attributes used to process the image matrix 103 in that unit. The processing units provide feedback to the system by adjusting the schema values and parameters.

According to this example, the image matrix 103 is first processed by the Colors processing unit 201, which re-parameterizes the image matrix 103 into prototypical color space that corresponds to fuzzy sets within the English color name universe of discourse. Linguistic variables are used to denote the graded memberships for the prototypical color associated with each pixel. The output from the Colors processing unit 201 is processed by the Derived Colors processing unit 202 which re-parameterizes colors to derived colors. Both processing units map to the universe of discourse representing human color names, yet designate different sets. For example, a point represented as “red” by the Colors processing unit 201 may map to “orange” after being processed by Derived Colors processing unit 202 if it corresponds to approximately equal membership in both the yellow and red color sets.

The output from both the Colors processing unit 201 and the Derived Colors processing unit 202 serve as input to the perceptual organization processing units, such as the Color Constancy processing unit 203, which in turn feeds the Grouping processing-unit 204. The output from the Grouping processing unit 204 in turn feeds the Symmetry processing unit 205 as well as the Centering processing unit 206. The output from the Centering processing unit 206 in turn feeds the Spatial processing 207. Finally the Figure/Ground processing unit receives the output from both the Symmetry processing unit 205 and the Spatial processing unit 207.

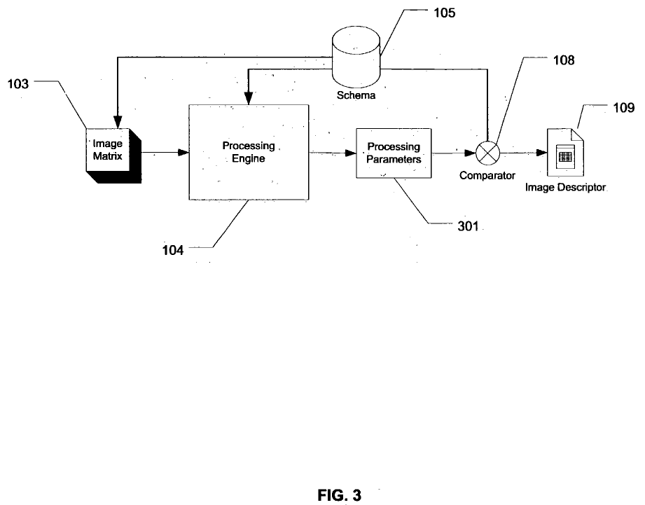

Each processing unit described contribute to parameter adjustments, which is used by the comparator 108 to direct processing cycle. For instance, the Color Constancy processing unit 203 alters transduction parameters for highly saturated pixels belonging to a single color prototype. This has the effect of decreasing the threshold sensitivity of the filters for the corresponding pixels in the next processing cycle as described in FIG. 3. In this manner, high-level contextual information such as Color Constancy adjusts local low-level processing, implementing both the time and context causality of the system. At each step, the processing unit interacts with the schema 105 to obtain values for processing and to update the schema 105 for the next processing unit. The specific processing units employed during each processing cycle as well as the sequence of processing may change depending on task requirements.

At the completion of the processing cycle, the system produces an image descriptor 109 which describe the image based on perceptual organization. The image descriptor 109 may be translated into other formats such as ASCII, XML, or proprietary formats for use in image indexing, image categorization, image searching, image manipulation, image recognition, etc., as well as serve as input to other systems designed for specific applications.

FIG. 3 illustrates the adaptive processing strategy and the causal nature of the system. The processing parameters 301 is predefined with default values at the beginning of processing. Each processing unit within the processing engine 104 performs a function and returns a parameter adjustment. At the end of a processing cycle the comparator 108 updates the parameter with adjustments. These adjusted parameters are then used in the next processing cycle. In this manner, the system implements a context dependent processing strategy.

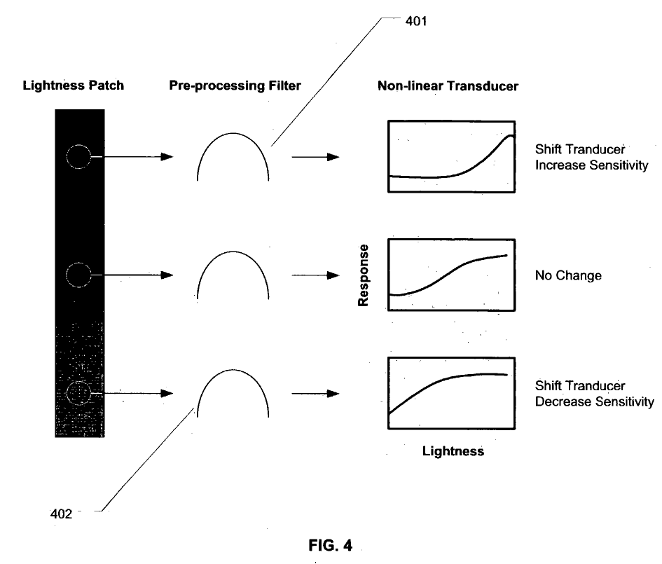

FIG. 4 provides a more specific example of how the adaptation process described in FIG. 3 applies in a contextual situation. The lightness gradient patch provides an example of the perceptual phenomenon of lightness constancy. As the system iteratively process an image, the Lightness Constancy processing unit updates the processing parameters such that the filters processing pixels in the dark regions 401 are more sensitive, and the filters processing pixels in the light regions 402 are less sensitive. The parameter adaptation is illustrated by the shift in transduction shown in the figure. Again, this provides an example of context dependent causality.

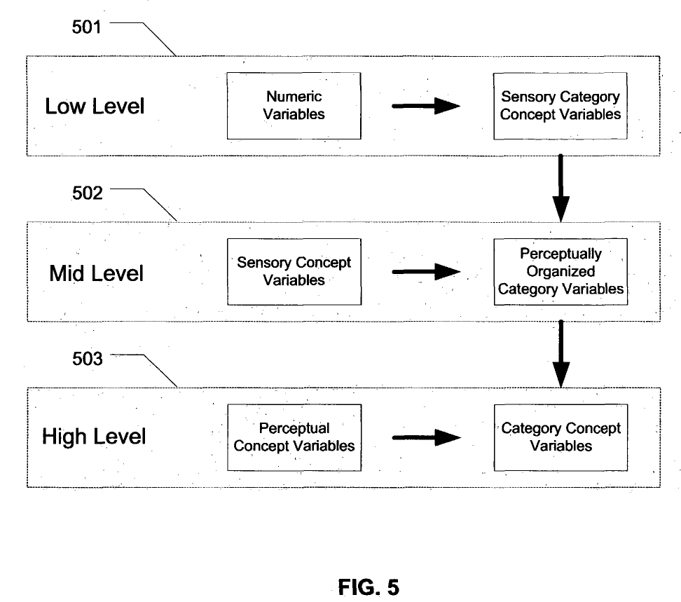

FIG. 5 illustrates how the system re-parameterizes information into category and concept variables. The digital image 101 contains crisp numeric values which are manipulated by the pre-processors 102 described above. Low level processing 501 map these numeric variables to appropriate sensory fuzzy linguistic variables. Mid-level processing 502 accept linguistic variables that reside in the sensory universe of discourse and re-parameterize it to perceptual organization variables such as good continuation, figure/ground, and “grouping parts”. Mid-level processing 502 implement the Gestalt psychology principle of the sum of the sensory variables is larger than its parts. High-level processing 503 accepts perceptually organized concept variables and return category variables which in turn form the basis for Artificial Intelligence (A.I.) tasks, such as object recognition. The processing path is not fixed. High-level processing units may accept input from low-level and mid-level processing units. High-level processing units, which process global context, however, may only affect low-level processing units through adaptive parameter adjustments in the next processing cycle.

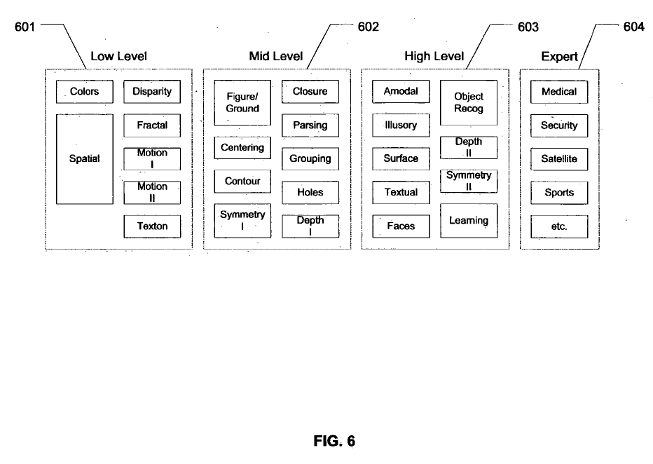

FIG. 6 shows the processing units corresponding to the level of processing within the system. The low level processing units 601 correspond to low level human visual processes such as recognition of colors and spatial relationships among objects; the mid level processing units 602 correspond to mid level human visual processes such as recognition of figures vs. ground and image symmetry; and the high level processing units 603 correspond to high level human visual processes such as recognition of textual and illusory contour. The system also supports the expert level processing units 604 which correspond to human visual processes for very specific task such as medical image analysis or satellite image processing.

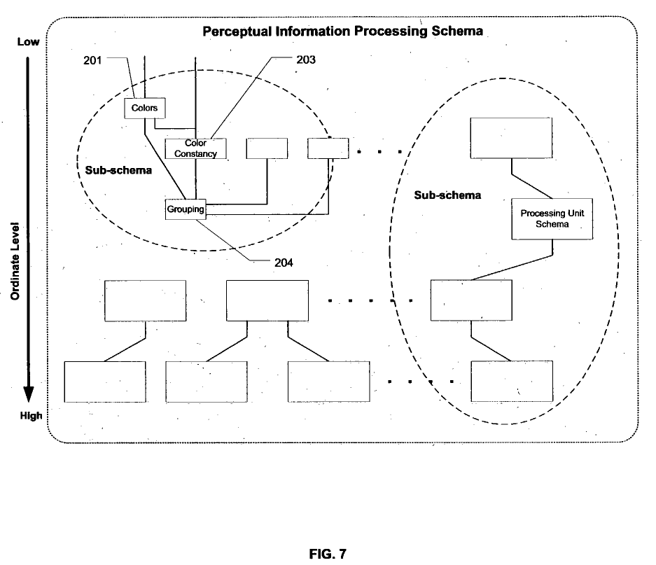

FIG. 7 illustrates the schema structure of the system with sub-schemas at multiple abstraction levels within the system. For example, the Colors 201, Color Constancy 203, and Grouping 204 processing units form a schema, which is subordinate to the system schema. In this case, the Grouping processing unit 204 is super-ordinate to the Colors 201 and Color Constancy 203 processing units which are both units of the primary level. The schemas follows human ordinate structure. Through the relative order of processing, the present invention designate a new ordinate structure that is used to label visual information.

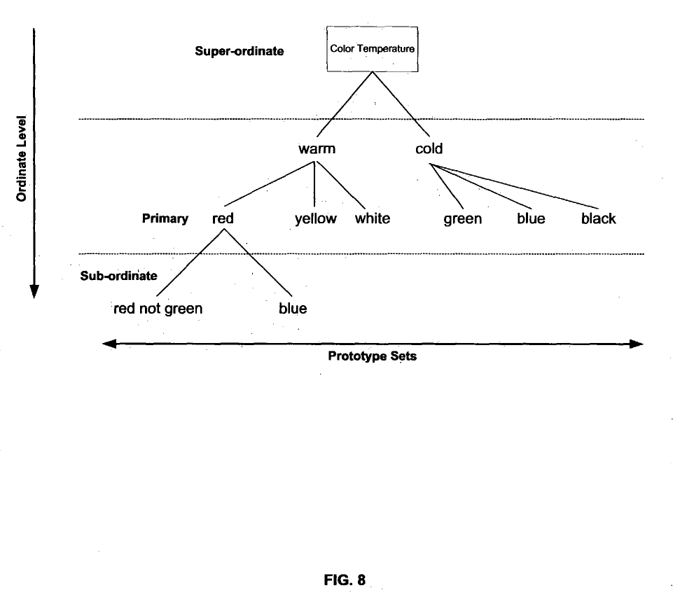

FIG. 8 shows an example of how the linguistic system variables form a schema. The color temperatures (warm and cold) processed by the Colors processing unit are super-ordinate variables. The red, yellow, white, green, blue, and black are primaries. This schema matches the human color category structure as found in an anthropological study by B. Berlin and P. Kay (1969). This FIG. 8 illustrates how psychological survey methods, in this case from anthropology and linguistics, combined with category theory [2] can be easily incorporated as schema by the system.

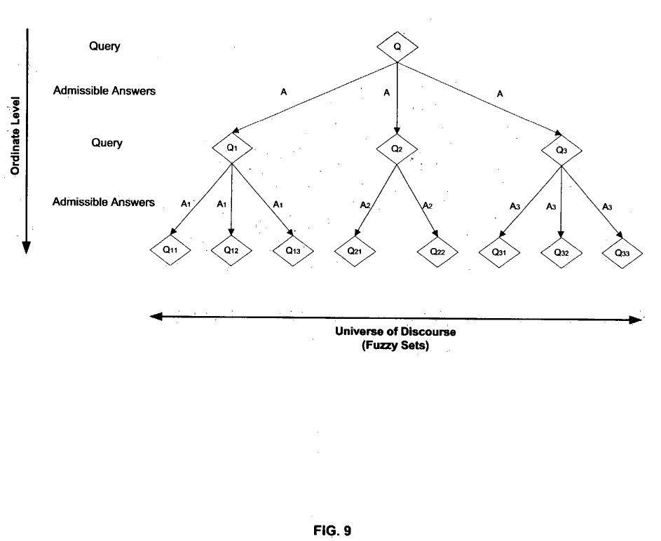

FIG. 9 is a diagrammatic illustration of how a composite fuzzy query system [5] implements the schematic structure of the processing engines. The query denoted

Q/A=? Category/attribute (1)

represents a single query and the expected answer set A consisting of admissible graded membership categories with truth values between zero and one. In this embodiment of the present invention, the perceptual schema constrains the answer sets, and a composite system implements the hierarchical nature of the system. As shown in the figure, the super-ordinate query Q/A=Q₁/A₁+Q₂/A₂+Q₃/A₃, where Q₁/A₁=Q₁₁+Q₁₂+Q₁₃. A composite question space operates on all possible answer sets subordinate to it in the schema [5].

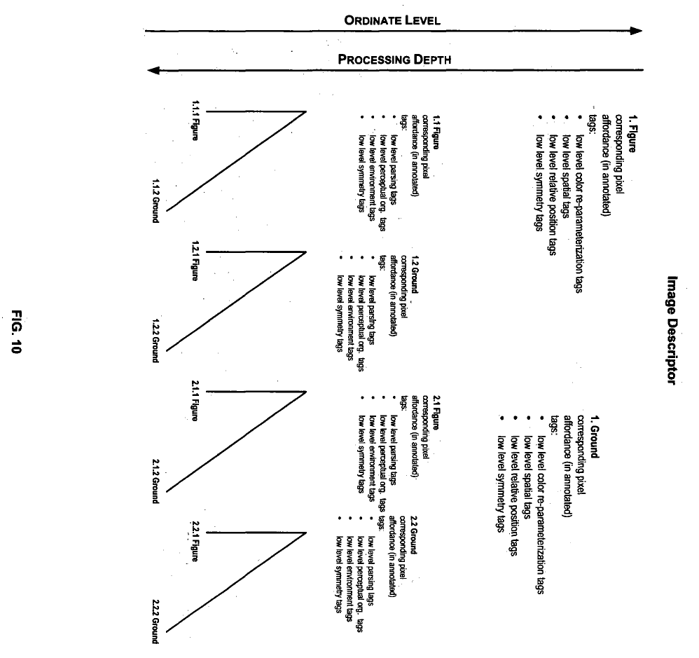

FIG. 10 is a diagrammatic illustration of one embodiment of the image descriptor. The vertical dimension indicates processing depth. As processing depth increases, the tags and tag level move from low-level to mid-level to high-level and finally to object recognition. The image descriptor index uniquely defines the processing path taken to arrive at a particular tag. The horizontal dimension broadly designates figure/ground segmentation. Each figure/ground contains the primary visual labels for that processing level. These primaries can be immediately understood, by any human. Subordinate data, used by the processing modules, correspond to processing not readily available to humans on a conscious level (in other words, any human could point out primary visual elements—if asked—but they may not be able to point out the subordinate information) such as spatial frequency components. Each figure is subdivided into its own figure/ground region.

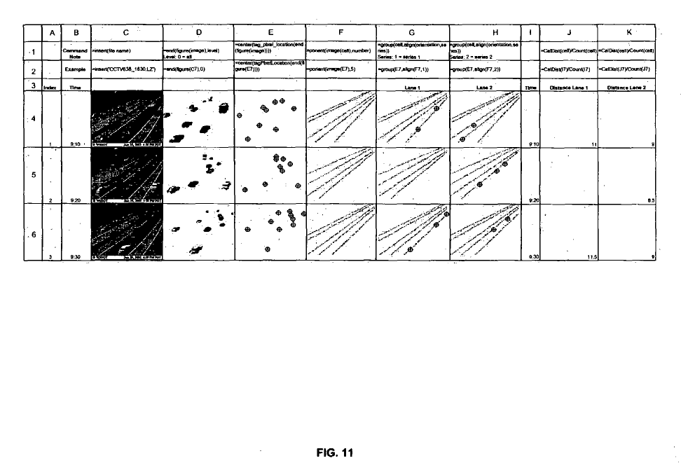

FIG. 11 illustrates a software application implemented using the present invention. This application allows the user to extract visual information from images and manipulate them as variables with simple commands and equations. The command/equations shown in rows 1 and 2 use the preferred embodiment of a new scripting language designed to perform manipulation of the image descriptors mentioned above and image segments tagged by the image descriptors. Row 1 demonstrates command syntax. Row 2 shows an example command. For example, the equation shown in cell C2 when entered in cell C4 results in the image file with the name “CCTV638_{—}1630.LZ” being inserted in cell C4.

The images shown in column C are pre-processed by the present invention's preferred embodiment as described above. Associated with each pre-processed image are image descriptors coding image data which may be manipulated by specific equations/commands. FIG. 10 illustrates the following example equations/commands and their effect:

The command “=end(figure(image),level)” iteratively extracts “figure” (as defined by the perceptual organization schema in the present invention and coded hierarchically in the GIT) from the specified image one by one to a specified level.

The command “=center(tag_pixel_location(end(figure(image))))” determines and displays the center pixel location for all figures designated, by (end(figure(image)))).

The command “=porient(image(cell),number)” determines and displays a specified number of most prominent orientations and draws a line depicting them.

The command “=group(cell,align(orientation,series))” applies the grouping perceptual organization rule; in this case proximity and good continuation. The command groups the figures with the closest specified orientation line.

The command “=CalDist(cell)/Count(cell)” calculates the distance between the elements in the specified cell and divides the result by the number of elements in the specified cell.

This FIG. 11 illustrates the preferred embodiment of a novel software application and the capability and versatility of the present invention to enable such application.

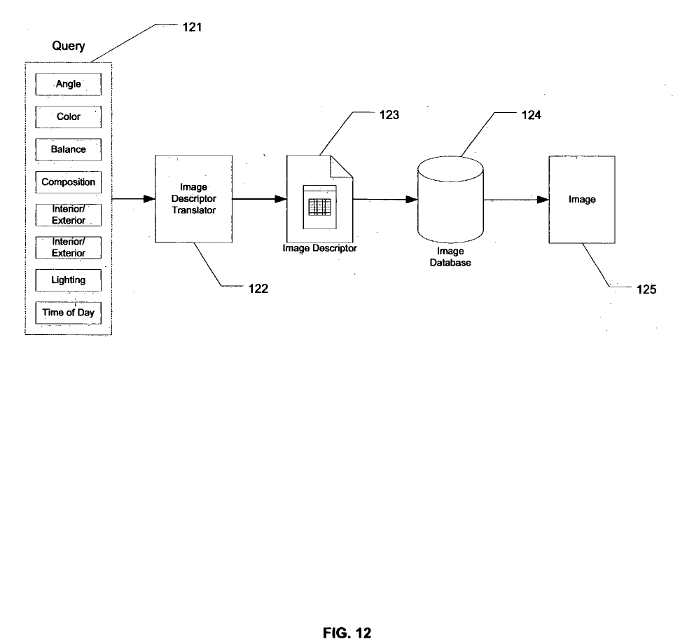

FIG. 12 illustrates the image retrieval process using the image descriptor. The user presents query 121 for a specific image in linguistic terms such as the general color scheme and composition of the image. The query 121 is processed by the image descriptor translator 122 to translate the linguistic terms into image descriptor 123. The resulting image descriptor 123 is compared with image descriptors of images stored in the image database 124. The image with image descriptor that best matched the image descriptor 123 is retrieved as the result 125.

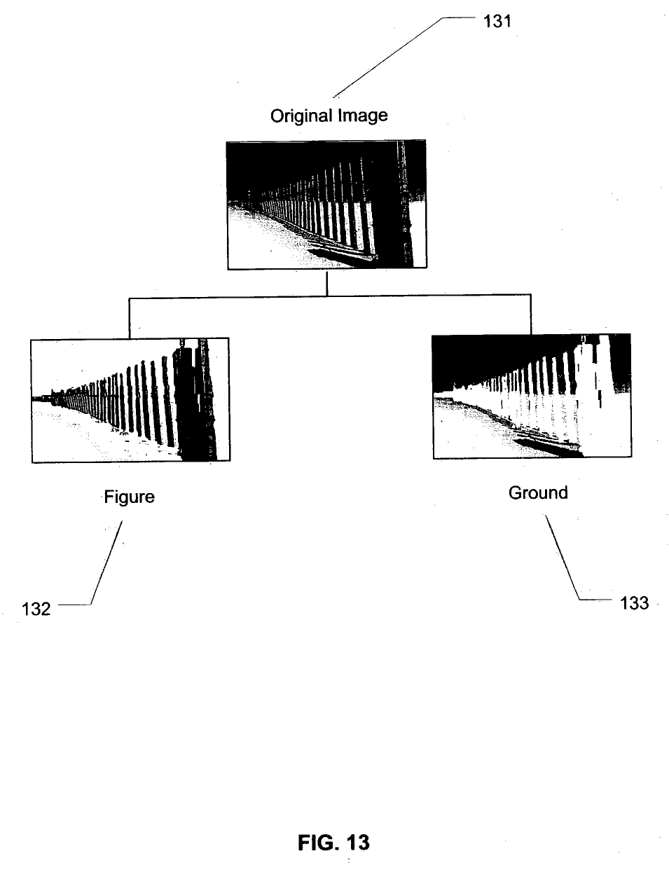

FIG. 13 shows an example of partial system output. FIG. 13 shows this embodiment of the present invention automatically segmented an image of a fence 131 in a snow covered ground with blue sky into a figure image 131 of the fence and a background image 132 of the snow covered ground and blue sky.

### Conclusion

The present invention discloses a technology platform for a broad range of applications concerning visual images. The platform and the newly defined data structure allows creation of new applications such as a spreadsheet software for managing and manipulating visual information, annotation software for labeling of visual images, photo management software for digital photography, software for visual search, etc. The platform, further allows creation of expert systems for image recognition and knowledge perception.

This concludes the description including the preferred embodiments of the present invention. The foregoing description of the preferred embodiment of the invention has been presented for the purpose of illustration and description. It is not intended to be exhaustive or to limit the invention to the precise form disclosed.

### References

The following references are incorporated by reference herein:

[1] Canny, J. F., 1986.

[2] Rosch, E., 1975, Cognitive representations of semantic categories, Journal of Experimental Psychology: General 104(3) 192-233.

[3] Sternberg, R. J., Cognitive Psychology, Second Edition, 1999, p. 263.

[4] Komatsu, L. K., 1992, Recent view on conceptual structure, Psychological Bulletin, 112(3), p.500-526.

[5] Zadeh, Lotfi, 1976, A fuzzy-algorithmic approach to the definition of complex or imprecise concepts, Journal of Man-Machine Studies, 8, 249-291.

We claim:

1. An electronic digital image processing system incorporating cognitive, psychophysical, and perceptual principles, comprising one or more pre-processors, a processing engine with multiple processing units each re-parameterizing input variables to graded category variables to accomplish processing functions such as color segmentation and grouping by similarities, a perceptual schema database, and an output generator that produces structured image data.

2. The system of claim 1, wherein the processing algorithms and mechanisms re-parameterize input variables which correspond to physical properties of the ambient image array to graded category or concept variables corresponding to perceptual principles, and cognitive and psychophysical prototypes.

3. The system of claim 1, wherein the system processes digital images in an adaptive fashion, with each processing unit making adjustments to the data in the schema and adapting the data adjustments made by other processing units in processing the digital image.

4. The system of claim 1, wherein the processing units are inter-dependent with each processing unit employing output from other processing units and provides output for use by other processing units in their respective processing function.

5. The system of claim 1, wherein a schema with hierarchical structure is employed to encode perceptual hypotheses, super-ordinate categories, primary visual primitives, and visual attributes.

6. The system of claim 1, wherein data derived by psychological survey methods, including identification of typicality metrics, prototypes, relative ordinate designation, and relative context within a data structure, are used in the processing of digital image.

7. The system of claim 1, wherein numerical data are re-parameterized into linguistic category data and organized within a perceptual schema and an image descriptor.

8. The system of claim 1, wherein a fuzzy perceptual inference system is employed to transform numeric data into linguistic data.

9. The system of claim 1, wherein an image descriptor, comprising of linguistic and numeric data is used to describe a digital image and organized relative to other variables designating ordinate position and corresponding level of human perceptual designation as well as world context, is used to provide perceptual decision-relative descriptions of a visual image.

10. The system of claim 5, wherein data derived by psychological survey methods including typicality survey and motor interaction studies is employed to construct schemas that incorporate expert human knowledge.

11. A data structure for describing the perceptual data of the digital image comprising:
numeric data that describe the digital image;
linguistic data that describe the digital image;
indices that identify the data with each level of processing such as ordinate level within schema structure, perceptual schema, and human categorization; and
labels that associate the data with perceptual concepts.

12. A method of query processing in an electronic image retrieval system, comprising:
receiving one or more query input describing the image in linguistic terms;
translating the linguistic query input into a query image descriptor that conforms to the schema of claim 2;
comparing the query image descriptor to the image descriptor of images stored in a database; and
retrieving the image with image descriptor that most closely matches the query image descriptor.

13. A method of analyzing visual information, comprising:
an electronic spreadsheet that accepts digital images and their image descriptors as input to its cells;
means for reading the data in the image descriptors; and
formulas that operate on the data contained in the image descriptors.
